(19) United States
(12) Patent Application Publication
(10) Pub. No.: US 2011/0156504 A1
(43) Pub. Date: Jun. 30, 2011

(54) MOTOR AND METHOD FOR MANUFACTURING THE SAME

(76) Inventors: YOSHIMI KURAHARA, HITACHI (JP); KOJI OBATA, HITACHI (JP)

(21) Appl. No.: 12/979,617

(22) Filed: Dec. 28, 2010

(30) Foreign Application Priority Data
Dec. 28, 2009 (JP) 2009-296662

(51) Int. Cl. H02K 3/30; B29C 41/20

(52) U.S. Cl. 310/43; 264/299

(57) ABSTRACT

A motor comprises a rotor having a permanent magnet, a stator core having a stator coil and a frame for accommodating therein the rotor and the stator core. The stator coil has a shape of a concentrated winding being fitted and wound to a tooth of an one-slot core as one slot per one phase in the stator core and has a molded high thermal conductivity resin for covering the stator coil. Both end faces of the stator coil are respectively provided with insulating and heat-transfer layers which are constituted by a part of the molded high thermal conductivity resin, and each of the electric insulating and heat-transfer layers is put in contact with the frame.

### CLAIM OF PRIORITY

The present application claims priority from Japanese application serial No. 2009-296662, filed on Dec. 28, 2009, the contents of which is hereby incorporated by references into this application.

### FIELD OF THE INVENTION

The present invention relates to a motor having an electric insulating and heat-transfer layer formed between a stator coil and a motor frame to enhance a heat dissipating property while ensuring electric insulation characteristics, as well as a method for manufacturing the motor.

### BACKGROUND OF THE INVENTION

According to a conventional motor, heat generated in a stator coil thereof is cooled naturally with outside air through a core and a frame of a motor or is cooled by forming a vent hole in a motor and passing air with a cooler installed in the exterior of the motor. There is known such a method as is disclosed in JP-A 2005-104620 wherein vanes are installed in the interior of a motor and cooling is performed by wind generated with rotation of a rotor. However, in the case of installing a cooling fan in the interior of a motor, a motor of a large size must be designed.

As an example of the method of directly dissipating heat generated in the coil to the frame, JP 2002-36449A discloses of interposing a heat-transfer sheet between a stator coil and a motor frame. According to the method of JP 2002-36449A, a heat transfer area since is limited by only between the motor coil and the frame, other portions not in contact with the sheet may have high temperatures. JP 2005-57840A although discloses a method of injecting a resin into a space between a motor coil and a motor frame to directly dissipate the heat, the thinner the resin between the motor coil and the frame to enhance the heat dissipating property, namely the narrower the space therebeteen, the more difficult the resin is injected into the space therebetween. Thereby, if planning on making a thin heat transfer resin, it may be impossible to ensure electric insulation between the coil and the frame.

An object of the present invention is to solve the problem of the conventional method of injecting resin into a space between a coil and a frame of a motor, that is, the problem of the resin being unable to be injected in a satisfactory manner in the case of narrowing the space (namely thinning the heat transfer resin) between the coil and the frame, and provide a motor capable of satisfying both an electric insulation characteristic and a heat dissipating property, as well as a method for manufacturing the motor.

### SUMMARY OF THE INVENTION

The present invention is proposed basically as follows to achieve the above-mentioned object. That is, in a motor comprising a rotor having a permanent magnet, a stator having a stator coil and a frame for accommodating therein the rotor and the stator, wherein the stator coil has a shape of a concentrated winding being fitted and wound to a tooth of an one-slot core as one slot per one phase in a stator core and has a molded high thermal conductivity resin for covering the stator coil, and wherein both end faces of the stator coil are respectively provided with electric insulating and heat-transfer layers which are constituted by a part of the molded high thermal conductivity resin, and each of the electric insulating and heat-transfer layers is put in contact with the frame.

In the above motor the present invention, it may optionally have the following features.

That is, each of the electric insulating and heat-transfer layers may have a thickness of 0.1 to d (d=thermal conductivity λ/200) mm as an optimum insulation thickness thereof, and the thickness corresponds to a distance from each end face of the stator coil to the frame.

The stator coil with the molded resin may be fitted to the tooth of an open slot core as the one-slot core.

The stator coil with the molded resin may be fitted to the tooth of a separated structure, the tooth having a flange for preventing the stator coil from dropping off and having a projection to be engaged in a recess portion of the stator core so that the tooth is secured to the stator core.

The molded resin for the stator coil may be of a high thermal conductivity-epoxy resin or unsaturated polyester resin containing an alumina filler.

The frame may have a structure being split into two in an axial direction of the motor and the electric insulating and heat-transfer layers at end faces of the stator coil with the molded resin are pressed from both sides of the split frames by the split frames so that the electric insulating and heat-transfer layers and the split frames are brought into contact with each other.

Furthermore, proposed is also the following method for manufacturing a motor. That is, in a method for manufacturing a motor comprising a rotor having a permanent magnet, a stator having a stator coil and a frame for accommodating therein the rotor and the stator, comprising:

a step of molding a high thermal conductivity resin around the stator coil having a shape of a concentrated winding;

a step of fitting the stator coil with the molded high thermal conductivity resin to a tooth of an one-slot core as one slot per one phase in the stator core; and

a step of mounting the stator core in the frame so that the molded high thermal conductivity resin at both end faces of the stator coil are pressed against the flame, thereby the molded high thermal conductivity resin serves as electric insulating and heat-transfer layers between the stator coil and the frame.

In the above motor manufacturing method motor of the present invention, it may optionally have the following features.

That is, molding the high thermal conductivity resin on the stator coil may be done at a thickness of 0.1 to d (d=thermal conductivity λ/200) mm of the resin as an optimum insulation thickness, and the thickness corresponds to a distance from each end face of the coil to the frame.

Furthermore, the step of fitting the stator coil with the molded high thermal conductivity resin may be done to the tooth of an open slot core as the one-slot core.

Furthermore, the step of fitting the stator coil with the molded high thermal conductivity resin may be done to the tooth of a separated structure, the tooth having a flange for preventing the stator coil from dropping off and also having a projection at one end of the tooth, while engaging the projection into a recess portion of the stator core so that the tooth is secured to the stator core.

Furthermore, in the method, the molded high thermal conductivity resin for the stator coil may be of a high thermal conductivity-epoxy resin or unsaturated polyester resin containing an alumina-filler.

Furthermore, in the method, wherein the frame may have a structure being split into two in an axial direction of the motor, and the step of mounting the flame may be done so as to have a structure in which the electric insulating and heat-transfer layers at end faces of the stator coil are pressed from both sides of the split frames by the split frames, so that the electric insulating and heat-transfer layers and the split frames are brought into contact with each other.

According to the present invention, in the stator of the motor, since each of the high thermal conductivity resin, which are a part of the molded resin and the electric insulating and heat-transfer layers are molded on the coil before installing (accommodating) the coil in the frame, is interposed between the coil and the frame, the heat dissipating property can be improved while ensuring a good electric insulation between the coil and the frame.

Besides, since the concentrated winding coil for each slot is molded, there accrues an advantage that thin electric insulating and heat-transfer layers can be formed at both ends of the coil.

Consequently, it is possible to provide a motor improved in heat dissipating property while ensuring electric insulation characteristics, and capable of attaining the reduction in size, as well as a method for manufacturing the motor.

### BRIEF DESCRIPTION OF THE DRAWINGS

FIG. 1 is an explanatory diagram of a motor according to an embodiment of the present invention (first embodiment);

FIG. 2 is an explanatory diagram showing on an enlarged diagram of a contact portion between the molded electric insulating and heat-transfer layer and the frame;

FIG. 3 is a graph showing a relation among partial breakdown voltage, heat dissipating property and electric insulating and heat-transfer layer thickness;

FIG. 4 is an explanatory diagram showing a step of forming a molded resin for the coil in processes of a motor manufacturing method (second embodiment);

FIG. 5 is an explanatory diagram showing a step of mounting the coil with the molded resin to a stator core in the second embodiment; and

FIG. 6 is an explanatory diagram showing another step of mounting the coil with the molded resin to a stator core.

### DETAILED DESCRIPTION OF THE PREFERRED EMBODIMENTS

Embodiments of the present invention will be described below with reference to the drawings.

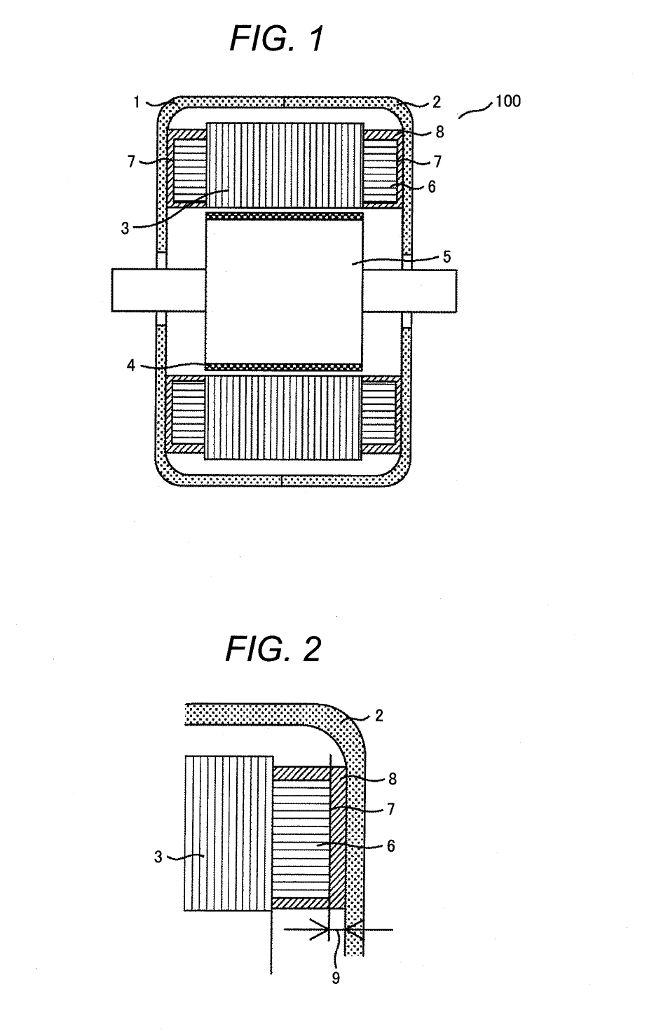

FIG. 1 is a sectional view of a motor according to a first embodiment of the present invention. The motor 100 is exampled with a permanent magnet synchronous motor having field permanent magnets 4 disposed on an outer surface of a rotor 5 in a circumferential direction of the rotor. Each of stator coils 6 is covered with a molded resin 8 having a high thermal conductivity before installing the motor 100, after molding the resin 8 on an outer surface of each coil 6, the coils 6 are installed into a stator core 3 respectively. For example, the molded resin 8 is made of a high thermal conductivity-epoxy resin or unsaturated polyester resin containing an alumina filler. The installation of the coils 6 with the molded resin 8 will be explained later referring to FIGS. 4 to 6. A frame for accommodating the rotor 5 with the permanent magnet 4 and the stator core 3 with the stator coil 6 is split into two of a first frame 1 and a second frame 2 in an axial direction of the motor. The first frame 1 and the second frame 2 is joined to each other with clamp bolts (omitted in Figs) so that those frames 1 and 2 respectively presses against both end faces 7 of each stator coil 6 in the axial direction of the motor 100 via the molded high thermal conductivity resin 8. In order to press the frames 1 and 2 against both end faces 7, the molded resin 8 has interferences at both end faces 7. Therefore, a part of the molded high thermal conductivity resin 8 is put in contact with the frames 1 and 2 at both end faces 7 of the coil 6 as electric insulating and heat-transfer layers between the coil 6 and the respective frames (1, 2).

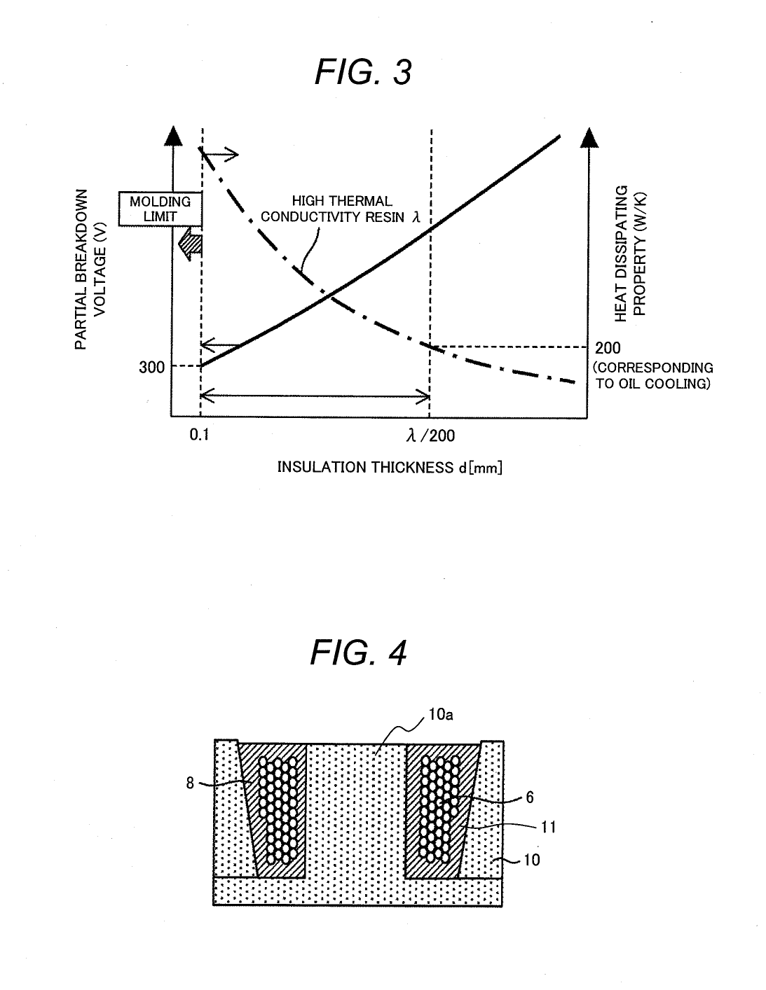

FIG. 2 is an enlarged diagram of a contact portion between the molded resin 8 as the electric insulating and heat-transfer layer and the frame 2 (ditto for frame 1) in the motor of this embodiment. FIG. 3 illustrates a relation among partial breakdown voltage, heat dissipating property and electric insulation thickness.

The electric insulating and heat-transfer layers, which are a part of the molded high thermal conductivity resin 8 at the both end faces 7 of the coil 6 favorably have a thickness of 0.1 to d (d=thermal conductivity λ/200) mm as an optimum insulation thickness thereof, and the thickness corresponds to a distance from each end face of the coil 6 to the frame (1, 2). For example, in FIG. 3, in the case of the motor having a partial breakdown voltage of 300V or less in the coil 6, the thickness (as indicated with a reference numeral 9 in FIG. 2) of the electric insulating and heat-transfer layer 8 from the coil end face 7 to an inside end surface of the second frame 2 is set at 0.1 mm. The reason is that molding such an electric insulating resin layer (resin coating) 8 at the end face 7 of the coil 6 is difficult to form at a thickness of less than 0.1 mm and that therefore a minimum thickness of the electric insulating and heat-transfer layer 8 is set at 0.1 mm. On the other hand, in the case of the motor having a partial breakdown voltage exceeding 300V in the coil 6, the layer 8 is made thicker according to characteristics. There is a problem that the thicker the electric insulating and heat-transfer layer 8 of the coil 6, the lower the heat dissipating property. Therefore, in the case where the heat transfer rate per unit area corresponding to that in a conventional oil-cooled structure is assumed to be 200 W/K and a resin with a thermal conductivity λW/mK is used as the molding material, a maximum insulation thickness is set at λ/200 mm.

### Second Embodiment

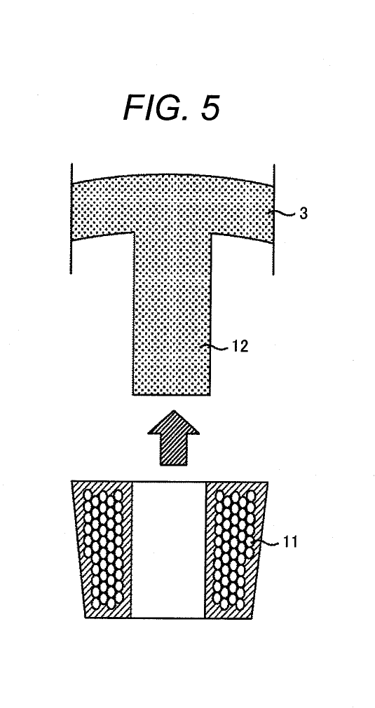

FIG. 4 shows a step of forming a molded resin for the stator coil 6 in processes of a motor manufacturing method. In a mold 10 for the molded resin 8 including the stator core 6, as shown in FIG. 4, by using a part 10a modeling a tooth 12 (shown in FIG. 5) of an one-slot core as one slot per one phase in the stator core 3, the stator coil 6 is formed into a concentrated winding shape in the interior of the mold 10, and the high thermal conductivity resin 8 is then molded by injecting into the mold 10. The resin 8 is exampled with an epoxy or unsaturated polyester resin 8 of a high thermal conductivity containing an alumina filler. Hereinafter, the coil 6 with the molded high thermal conductivity resin 8 also is called as a molded coil 11.

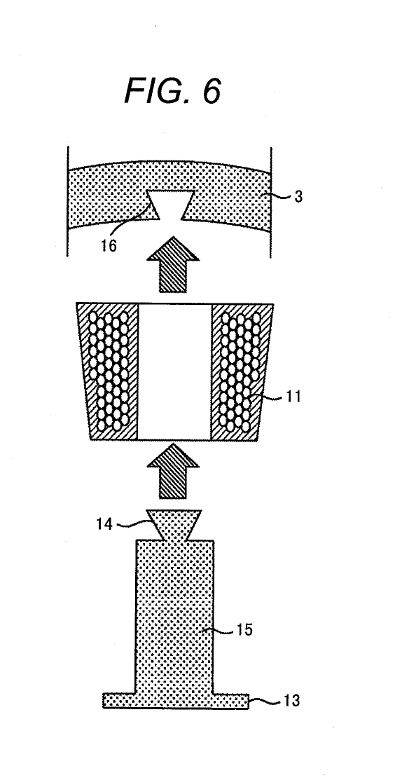

FIGS. 5 and 6 each illustrate a fabrication process of mounting the molded coil 11 to the stator core 3. The molded coil 11 is fitted to the tooth 12 of the open slot stator core 3. Alternatively, the molded coil 11 is fitted to a separated tooth 15, the tooth 15 having a flange 13 for preventing the molded coil 11 from dropping off and a projection 14 for mounting to the stator core 3, then the molded coil 11 thus fitted on the tooth 15 is mounted to the stator core 3 formed as a separate body and having a concave portion 16.

The present invention is applicable to a motor to be improved in both electric insulation characteristics and heat dissipating property, as well as a method for manufacturing the motor.

What is claimed is:

1. A motor comprising a rotor having a permanent magnet, a stator having a stator coil and a frame for accommodating therein the rotor and the stator, wherein the stator coil has a shape of a concentrated winding being fitted and wound to a tooth of an one-slot core as one slot per one phase in a stator core and has a molded high thermal conductivity resin for covering the stator coil, and wherein both end faces of the stator coil are respectively provided with electric insulating and heat-transfer layers which are constituted by a part of the molded high thermal conductivity resin, and each of the electric insulating and heat-transfer layers is put in contact with the frame.

2. The motor according to claim 1,
wherein each of the electric insulating and heat-transfer layers has a thickness of 0.1 to d (d=thermal conductivity λ/200) mm as an optimum electric insulation thickness thereof, and the thickness corresponds to a distance from each end face of the stator coil to the frame.

3. The motor according to claim 1,
wherein the stator coil with the molded resin is fitted to the tooth of an open slot core as the one-slot core.

4. The motor according to claim 1,
wherein the stator coil with the molded resin is fitted to the tooth of a separated structure, the tooth having a flange for preventing the stator coil from dropping off and having a projection to be engaged in a recess portion of the stator core so that the tooth is secured to the stator core.

5. The motor according to claim 1,
wherein the molded resin for the stator coil is of a high thermal conductivity-epoxy resin or unsaturated polyester resin containing an alumina filler.

6. The motor according to claim 1,
wherein the frame has a structure being split into two in an axial direction of the motor and the electric insulating and heat-transfer layers at end faces of the stator coil with the molded resin are pressed from both sides of the split frames by the split frames so that the electric insulating and heat-transfer layers and the split frames are brought into contact with each other.

7. A method for manufacturing a motor comprising a rotor having a permanent magnet, a stator having a stator coil and a frame for accommodating therein the rotor and the stator, comprising:
a step of molding a high thermal conductivity resin around the stator coil having a shape of a concentrated winding;
a step of fitting the stator coil with the molded high thermal conductivity resin to a tooth of an one-slot core as one slot per one phase in a stator core; and
a step of mounting the stator core in the frame so that the molded high thermal conductivity resin at both end faces of the stator coil are pressed against the flame, thereby the molded high thermal conductivity resin serves as electric insulating and heat-transfer layers between the stator coil and the frame.

8. The method according to claim 7,
wherein the step of molding the high thermal conductivity resin on the stator coil is done at a thickness of 0.1 to d (d=thermal conductivity λ/200) mm of the resin as an optimum electric insulation thickness, and the thickness corresponds to a distance from each end face of the coil to the frame.

9. The method according to claim 7,
wherein the step of fitting the stator coil with the molded high thermal conductivity resin is done to the tooth of an open slot core as the one-slot core.

10. The method according to claim 7,
wherein the step of fitting the stator coil with the molded high thermal conductivity resin is done to the tooth of a separated structure, the tooth having a flange for preventing the stator coil from dropping off and also having a projection at one end of the tooth, while engaging the projection into a recess portion of the stator core so that the tooth is secured to the stator core.

11. The method according to claim 7,
wherein the molded high thermal conductivity resin for the stator coil is of a high thermal conductivity-epoxy resin or unsaturated polyester resin containing an alumina-filler.

12. The method according to claim 7,
wherein the frame has a structure being split into two in an axial direction of the motor, and the step of mounting the flame is done so as to have a structure in which the electric insulating and heat-transfer layers at end faces of the stator coil are pressed from both sides of the split frames by the split frames, so that the electric insulating and heat-transfer layers and the split frames are brought into contact with each other.
